(19) United States
(12) Patent Application Publication
(10) Pub. No.: US 2017/0014007 A1
(43) Pub. Date: Jan. 19, 2017

(54) HAND DRYER

(71) Applicant: FFUUSS 2013, S.L., Solsona, Lleida (ES)

(72) Inventor: Oscar Ros Marin, Solsona, Lleida (ES)

(21) Appl. No.: 15/118,000

(22) PCT Filed: Feb. 12, 2015
(86) PCT No.: PCT/ES2015/070089

§ 371 Date: Aug. 10, 2016

(30) Foreign Application Priority Data
Feb. 12, 2014 (ES) U201430195

(51) Int. Cl. A47K 10/48; F26B 25/00

(52) U.S. Cl. CPC A47K 10/48; F26B 25/009

(57) ABSTRACT

A hand dryer (1) comprising a cavity (2) intended to receive the hands of a user, which comprises an operation control unit (3), the cavity (2) being provided with at least one presence sensor (4) to activate drying, characterised in that it comprises status sensors (5) for several of the components thereof connected to the control unit (3), wherein the control unit (3) comprises wireless transmission means (6) of said statuses and wherein the control unit (3) is configured to activate the wireless transmission of said statuses when the presence sensor (4) detects a predetermined sequence.

### TECHNICAL FIELD

The present invention relates to a hand dryer that enables optimal maintenance.

### BACKGROUND OF THE INVENTION

Hand dryers comprising a cavity intended to receive the hands of a user are known, comprising an operation control unit, the cavity being provided with at least one presence sensor to activate drying.

These hand dryers are conceived to work almost continuously, with a very high workload. In order to make the hand dryer operational again when a component fails, or when the water tray intended to collect the water droplets that fall from the hands of the user is full, it is necessary to notify that it is no longer operational, detect the breakdown and act on the hand dryer in order to make it operational again.

This sequence must be carried out as quickly as possible.

In the known hand dryers, the full tray condition tends to be evident due to the presence of water in the floor beneath the hand dryer, a situation that is not at all desirable due to the unclean appearance it entails.

Furthermore, in order for the person responsible for the maintenance to locate the failure, they must access the inside of the hand dryer, for which reason it must be disassembled, which entails time and cost.

### DESCRIPTION OF THE INVENTION

In order to resolve the drawbacks of the state of the art, or minimise them, the present invention proposes a hand dryer comprising a cavity intended to receive the hands of a user, comprising an operation control unit, the cavity being provided with at least one presence sensor to activate drying, which is characterised in that it comprises status sensors for several of the components thereof connected to the control unit, wherein the control unit comprises wireless transmission means of said statuses.

In this way, it is possible to know the inner status of the hand dryer from the outside and act accordingly.

Preferably, the control unit is configured to activate the wireless transmission of said statuses when it receives an activation signal.

Preferably, the activation signal is activated when the presence sensor detects a predetermined sequence or when the hand dryer is wirelessly sent the activation signal.

In this way, whether for a routine control or after the occurrence of a breakdown, the person responsible for the maintenance must only carry out a break sequence of the hand presence sensor(s), after which the transmission of the component status of the hand dryer is activated.

Preferably, the wireless transmission means operate with Bluetooth communication protocol.

Alternatively or additionally, the wireless transmission means operate via Wi-Fi.

This advantageously enables the hand dryer to be connected to a service platform, especially management and maintenance services for one or more hand dryers.

Advantageously, the control unit is configured to order the transmission of information stored in the control unit.

According to several optional characteristics of the invention, which may be combined if technically possible:
the information includes the work cycles carried out by the hand dryer, the time it has been in operation, or the increase and decrease in voltage it has undergone, the time the preheating unit has been in operation, if the unit includes the same.
the components include a collection tray for the water collected at the bottom of the cavity.
the hand dryer comprises a laser pointer arranged in the lower portion of the hand dryer and oriented towards the ground, the laser pointer being connected to the control unit, the control unit being configured to activate the laser pointer when a component of the hand dryer is not operational. Advantageously, this activation is intermittent.
the control unit is configured to activate the laser pointer when the tray is full. Preferably, this activation is continuous.
the hand dryer comprises light sources arranged in the mouth of the cavity for receiving hands.
the control unit is configured to activate a lighting sequence in the light sources.

Lastly, the sequence includes colour and strength variations of the light emitted by the light sources.

### BRIEF DESCRIPTION OF THE DRAWINGS

As a complement to the description, and for the purpose of helping to make the characteristics of the invention more readily understandable, in accordance with a practical embodiment thereof, said description is accompanied by a set of figures constituting an integral part thereof, which by way of illustration and not limitation represent the following:

FIG. 1 is a perspective view of a hand dryer that the present invention generally refers to.

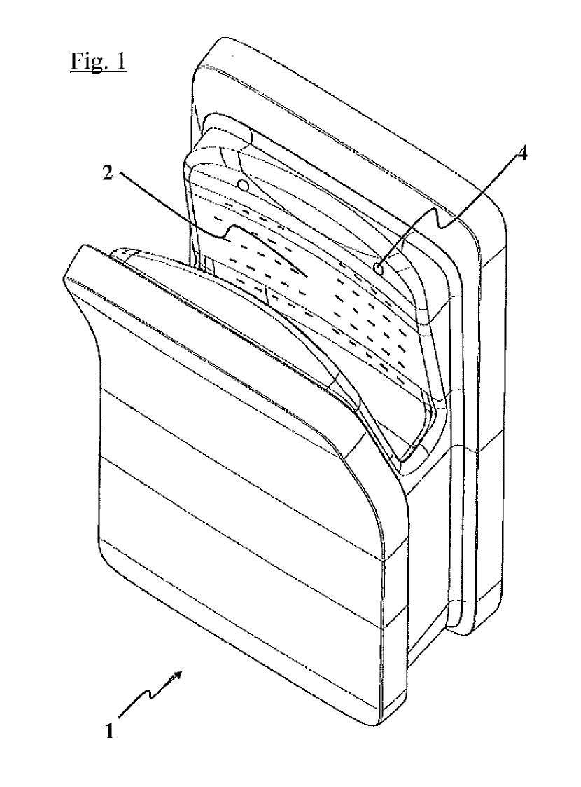

FIG. 2 is a perspective view of the hand dryer according to the invention, in which the lower portion thereof may be seen.

FIG. 3 shows a flowchart showing the connections between the main components of the hand dryer.

FIG. 4 is an upper perspective view showing the arrangement of the light sources in the mouth of the hand dryer.

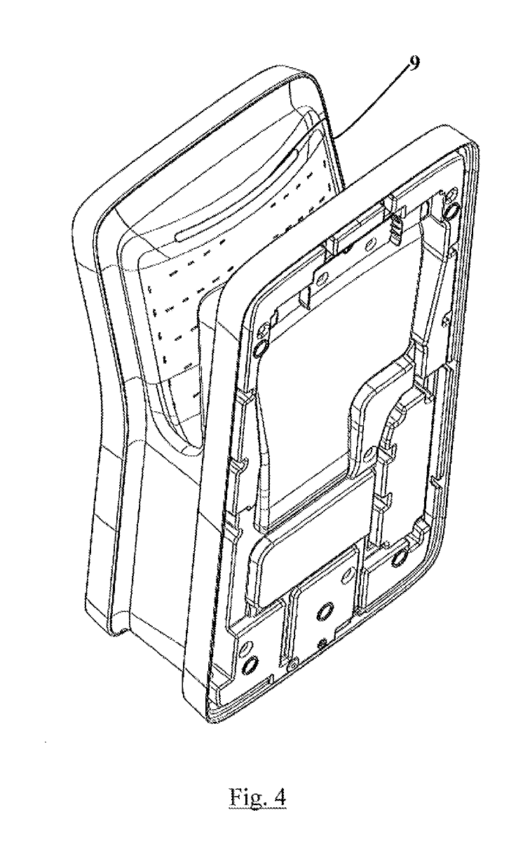

### DESCRIPTION OF AN EMBODIMENT OF THE INVENTION

As may be seen in the figures, the invention relates to a hand dryer 1 comprising a cavity 2 intended to receive the hands of a user, comprising an operation control unit 3, the cavity 2 being provided with at least one presence sensor 4 to activate drying.

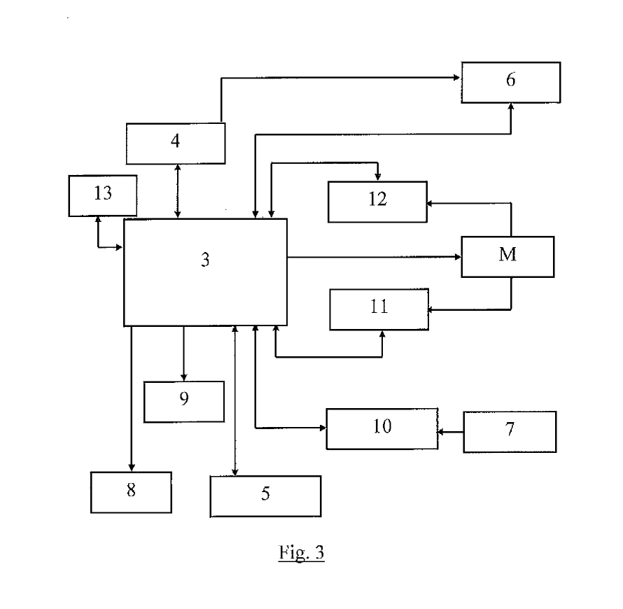

Specifically, according to a preferred embodiment, as may be seen in FIG. 3, the hand dryer comprises status sensors 5 for several of the components thereof connected to the control unit 3, wherein the control unit 3 comprises wireless transmission means 6, which preferably operate with Bluetooth communication protocol, of said statuses and wherein the control unit 3 is configured to activate the wireless transmission of said statuses when the presence sensor 4 detects a predetermined sequence.

The control unit may also activate the wireless transmission, for example, via an activation signal sent externally.

The connection may be Wi-Fi instead of Bluetooth, and according to the needs, may be transmitted continuously or intermittently.

In particular, the Wi-Fi connection enables one or more hand dryers to be connected to a management and maintenance platform. In particular, this enables the manager to carry out the maintenance of many units remotely themselves.

They may also know the status of the hand dryers and carry out predictive maintenance thereof, for example, via vibration or anomalous operation status analysis of components provided with sensors.

It is also provided that some variants of the hand dryer include an informative screen directed towards the user of the hand dryers. The manager may control the content shown on the screen via wireless communication.

The components include a collection tray 7 for the water collected at the bottom of the cavity 2. For example, when it is almost full, the maintenance staff may be notified so that they remove the water and the hand dryer may continue to work.

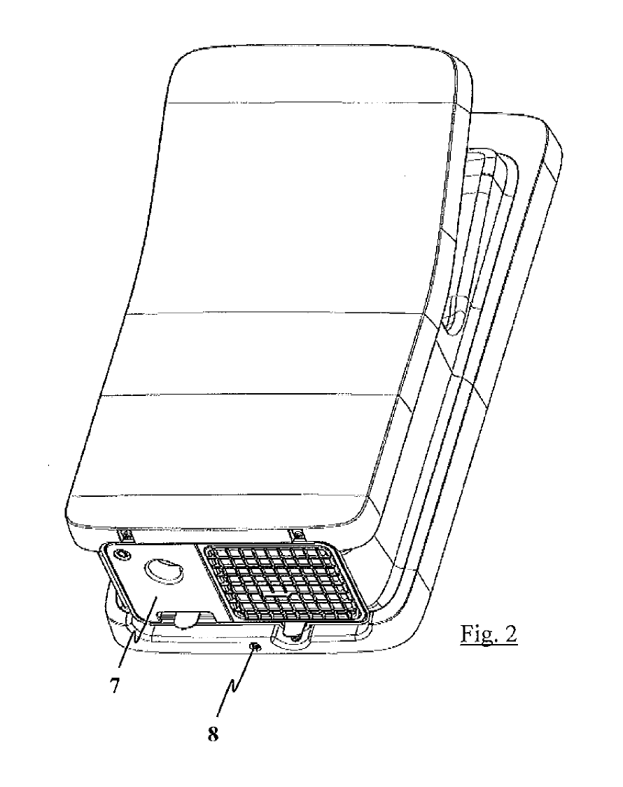

As may be seen in FIG. 2, the hand dryer comprises a laser pointer 8 arranged in the lower portion of the hand dryer 1 and oriented towards the ground, the laser pointer 8 being connected to the control unit 3, the control unit 3 being configured to activate the laser pointer 8 when a component of the hand dryer is not operational.

This activation may be intermittent, in order for a breakdown to be more visible.

Furthermore, the control unit 3 is configured to activate the laser pointer when the tray 7 is full. This activation is continuous in order to differentiate the full tray situation from a breakdown.

According to another advantageous aspect of the invention, which may be considered an invention in itself, the hand dryer comprises light sources 9 arranged in the mouth of the cavity 2 for receiving hands and the control unit 3 is configured to activate a lighting sequence in these light sources 9.

This sequence includes colour and strength variations of the light emitted by the light sources 9.

The following 25-second cycle is preferably proposed for the LEDs whilst the motor is activated by a user.

These are three continuous colour changes:

It starts with BLUE RGB(0,0,255) and every 100 ms the red increases such that in 8 seconds it turns into MAGENTA RGB(255,0,255)

From MAGENTA RGB(255,0,255), every 100 ms the red decreases such that in 8 seconds it turns into BLUE RGB(0,0,255)

From BLUE RGB(0,0,255), every 100 ms the green increases such that in 8 seconds it turns into CYAN RGB(0,255,255)

Clearly, the wireless communication also enables the lighting sequences to be configured at will and remotely.

As may be seen in FIG. 3, the control unit is connected to:
Current 11 and temperature 12 sensors for the motor;
A tray full switch 10;
An air temperature sensor 13;

In this text, the word “comprises” and variants thereof (such as “comprising”, etc.) should not be understood in an exclusive sense, i.e. they do not exclude the possibility of that which is described including other elements, steps, etc.

Also, the invention is not limited to the specific embodiments of the hand dryer described, but rather encompasses the variations that a person with average skill in the art could make (e.g. in terms of choice of materials, dimensions, components, design, etc.), within the scope of what may be deduced from the claims.

1. A hand dryer (1) comprising a cavity (2) intended to receive the hands of a user, which comprises an operation control unit (3), the cavity (2) being provided with at least one presence sensor (4) to activate drying, characterised in that it comprises status sensors (5) for several of the components thereof connected to the control unit (3), wherein the control unit (3) comprises wireless transmission means (6) of said statuses.

2. The hand dryer according to claim 1, wherein the control unit (3) is configured to activate the wireless transmission of said statuses when it receives an activation signal.

3. The hand dryer according to claim 2, wherein the activation signal is generated when the presence sensor (4) detects a predetermined sequence or when the hand dryer is wirelessly sent the activation signal.

4. The hand dryer according to claim 1, wherein the wireless transmission means (6) operate with Bluetooth communication protocol.

5. The hand dryer according to claim 1, wherein the wireless transmission means (6) operate via Wi-Fi.

6. The hand dryer according to claim 5, which is connected to a service platform.

7. The hand dryer according to claim 1, wherein the control unit (3) is configured to order the transmission of information stored in the control unit.

8. The hand dryer according to claim 7, wherein this information includes the work cycles carried out by the hand dryer, the time it has been in operation, or the increase and decrease in voltage it has undergone, the time the preheating unit has been in operation, if the unit includes the same.

9. The hand dryer according to claim 1, wherein said components include a collection tray (7) for the water collected at the bottom of the cavity (2).

10. The hand dryer according to claim 1, which comprises a laser pointer (8) arranged in the lower portion of the hand dryer (1) and oriented towards the ground, the laser pointer (8) being connected to the control unit (3), the control unit (3) being configured to activate the laser pointer (8) when a component of the hand dryer is not operational.

11. The hand dryer according to claim 10, wherein said activation is intermittent.

12. The hand dryer according to claims 9, wherein the control unit (3) is configured to activate the a laser pointer when the tray (7) is full.

13. The hand dryer according to claim 12, wherein said activation is continuous.

14. The hand dryer according to claim 1, which comprises light sources (9) arranged in the mouth of the cavity (2) for receiving hands.

15. The hand dryer according to claim 14, wherein the control unit (3) is configured to activate a lighting sequence in the light sources (9).

16. The hand dryer according to claim 15, wherein the sequence includes colour and strength variations of the light emitted by the light sources (9).

17. The hand dryer according to claim 2, wherein the wireless transmission means (6) operate via Wi-Fi.

18. The hand dryer according to claim 3, wherein the wireless transmission means (6) operate via Wi-Fi.

19. The hand dryer according to claim 10, wherein the control unit (3) is configured to activate the laser pointer when the tray (7) is full.
